(19) United States
(12) Patent Application Publication
(10) Pub. No.: US 2010/0125791 A1
(43) Pub. Date: May 20, 2010

(54) USER INTERFACE FOR A TELECOMMUNICATION AND MULTIMEDIA MANAGEMENT SYSTEM AND METHOD

(75) Inventors: Thomas E. Katis, Jackson, WY (US); James T. Panttaja, Healdsburg, CA (US); Mary G. Panttaja, Healdsburg, CA (US); Matthew J. Ranney, Oakland, CA (US); Daniel B. Leifker, San Francisco, CA (US); Justin V. Lee, Berkeley, CA (US)

Correspondence Address: BEYER LAW GROUP LLP / REBELVOX, P.O. BOX 1687, Cupertino, CA, 95015-1687, US

(73) Assignee: REBELVOX, LLC, San Francisco, CA (US)

(21) Appl. No.: 12/271,178

(22) Filed: Nov. 14, 2008

(51) Int. Cl. G06F 3/00

(52) U.S. Cl. 715/716

(57) ABSTRACT

A User Interface or UI that generates a progressive timeline visualization of a conversation, including representations of the media contribution of each participant and tools to navigate and review the representations of the media of the conversation.

### BACKGROUND

1. Field of the Invention

This invention pertains to a user interface (UI) for a telecommunication and multimedia management system and method, and more particularly, to a UI that generates a progressive timeline visualization of a conversation, including representations of the media contribution of each participant and tools to navigate and review the representations of the media of the conversation.

2. Description of Related Art

The current state of voice communications suffers from inertia. In spite of automated switching, high bandwidth networks and technologies such as satellites, fiber optics, Voice over IP (VoIP), wireless and cellular networks, there has been little change in how people use telephones. One is still required to pick up the phone, dial another party, wait for a connection to be made, and then engage in a full-duplex, synchronous conversation with the dialed party. If the recipient does not answer, no connection is made, and the conversation does not take place.

At best, a one-way voice message may be left if the recipient has voice mail. The process of delivering the voice mail, however, is burdensome and time consuming. The caller is required to wait for the phone on the other end to stop ringing, transition into the voice mail system, listen to a voice message greeting, and then leave the message. Current voice mail systems are also inconvenient for the recipient. The recipient has to dial a code to access their voice mail, navigate through a series of prompts, listen to any earlier received voice messages in the queue, and then finally listen to the message of the sender.

Another drawback with typical voice mail systems is the inability to organize or permanently archive voice messages. With some voice mail systems, a user may save a message, but it is automatically deleted after a predetermined period of time and lost forever.

Yet another problem with current voice mail systems is that a connection must be made between the caller and the voice mail system before a message can be left. If no connection is made, there is no way for the caller to leave a message.

Current telephone systems are based on relatively simplistic usage patterns: real-time live calls or disjointed voice mail messages, which are typically deleted as they are heard. These forms of voice communications do not capture the real power that can be achieved with voice communication or take advantage of the advances of network speed and bandwidth that is now available. Also, if the phone network is down, or is inaccessible, (e.g., a cell phone user is in an area of no coverage or the phone system has temporarily run out of resources), no communication can take place.

In general, telephone based communications have not kept pace with the advances in text-based communications. Instant messaging, emailing, faxing, chat groups, and the ability to archive text messages, are all commonplace with text based communications. Compared to text communication systems there are few existing tools available to manage and/or archive voice communications. Voice mail is the notable exception, but it suffers from the limitations as outlined above.

The corporate environment provides just one example of the weakness in current voice communication tools. There is currently no integrated way to manage voice communications as a corporate asset across an organization. Employees generally do not record or persistently store their phone conversations. Most business related voice communication assets are gone as quickly as the words are spoken, with no way to manage or store the content of those conversations in any manageable form.

As an illustrative example, consider a sales executive at a company. During the course of a busy day, the executive may make a number of calls, closing several sales with customers over the phone. Without the ability to organize, store, and later retrieve these conversations, there is no way for the executive to resolve potential issues that may arise, such as recalling the terms of one deal versus another, or challenging a customer who disputes the terms of a previously agreed upon sale. If this executive had the ability to easily retrieve and review conversations, these types of issues could be easily and favorably resolved.

Current tactical radio systems, such as those used by the military, fire, police, paramedics, rescue teams, and first responders, also suffer from a number of deficiencies. Most tactical radio communication must occur through a “live” radio connection between the sender of a message and a recipient. If there is no radio connection between the two parties, there can be no communication. Urgent messages cannot be sent if either the sender or the receiver does not have access to their radio or a radio circuit connection is not established. Tactical communications are therefore plagued with several basic problems. There is no way: (i) to guarantee the delivery of messages: (ii) for a recipient to go back and listen to a message that was not heard in real time; (iii) to control the granularity of the participants in a conversation; and (iv) for the system to cope with the lack of adequate signal for a live conversation. If a message is not heard live, it is missed. There are no tools for either the sender or a recipient to manage, prioritize, archive, and later retrieve (i.e. time-shift) the messages of a conversation that were previously sent.

Yet another drawback with tactical radio communication systems is that only one radio may transmit at a time per channel. Consider an example of a large building fire, where multiple teams of fire fighters, police, and paramedics are simultaneously rescuing victims trapped in the building, fighting the fire, providing medical aid to victims, and controlling bystanders. If each of the teams is using the same channel, communications may become crowded and chaotic. Transmissions get “stepped on” when more than one person is transmitting at the same time. Also there is no way to differentiate between high and low priority messages. A team inside the burning building fighting the fire or rescuing trapped victims should have a higher priority over other teams, such as those controlling bystanders. If high priority messages are stepped on by lower priority messages, it could not only hamper important communications, but could endanger the lives of the fire fighters and victims in the building.

One possible solution to the lack of ability to prioritize messages is to use multiple channels, where each team is assigned a different channel. This solution, however, creates its own set of problems. How does the fire chief determine which channel to listen too at any point in time? How do multiple teams communicate with one another if they are all on different channels? If one team calls for urgent help, how are other teams to know if they are listening to other channels? While multiple channels can alleviate some issues, it can also cause confusion, creating more problems than if a single channel is used.

The lack of management tools that effectively prioritize messages, that allow multiple conversations to take place at the same time, that enable the time-shifting of messages to guarantee delivery, or that support archiving and storing conversations for later retrieval and review, all contribute to the problems associated with tactical radios. In first responder situations, such as with the military, police, and fire, effective communication tools can literally mean the difference between life and death, or the success or failure of a mission. The above burning building example is useful in illustrating just some of the issues with current tactical radio communications. Similar problems exist with the military, police, first responders and others who use tactical communications.

For the reasons recited above, telephone, voicemail, and tactical voice communications systems are inadequate. A User Interface or UI that generates a progressive timeline visualization of a conversation, including representations of the media contribution of each participant and tools to navigate and review the representations of the media of the conversation, is therefore needed.

### SUMMARY OF THE INVENTION

The present invention is directed to a User Interface or UI that generates a progressive timeline visualization of a conversation, including representations of the media contribution of each participant and tools to navigate and review the representations of the media of the conversation.

### BRIEF DESCRIPTION OF THE DRAWINGS

The invention may best be understood by reference to the following description taken in conjunction with the accompanying drawings, which illustrate specific embodiments of the invention.

FIG. 1 is an exemplary “dashboard” for the User Interface (UI) of the present invention.

FIG. 2 is a timeline at the start of a conversation with the UI of to the present invention.

FIG. 3 is a timeline of the conversation showing just the media history of a conversation according to the present invention.

FIG. 4 is a diagram illustrating a complete conversation timeline of the present invention.

FIG. 5 is a “zoom” window feature for reviewing the media of the conversation timeline of the present invention.

FIG. 6 is a voice to text transcription of the media of the conversation of the present invention.

FIGS. 7A and 7B illustrate a timeline of a conversation according to another embodiment of the present invention.

FIGS. 8A and 8B illustrate another timeline of a conversation according to yet another embodiment of the present invention.

It should be noted that like reference numbers refer to like elements in the figures.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

In U.S. application Ser. No. 12/028,400 filed on Feb. 8, 2008 and U.S. application Ser. No. 12/192,890 filed on Aug. 15, 2008, both entitled “Telecommunication and Multimedia Management Method and Apparatus”, an improved voice and other media communication and management system and method is disclosed. The system and method provides one or more of the following features and functions: (i) enabling users to participate in multiple conversation types (MCMS), including live phone calls, conference calls, voice messaging, consecutive (MCMS-C) or simultaneous (MCMS-S) communications; (ii) enabling users to review the messages of conversations in either a live mode or a time-shifted mode (voice messaging); (iii) enabling users to seamlessly transition a conversation between a synchronous “live” near real-time mode and a time shifted mode; (iv) enabling users to participate in conversations without waiting for a connection to be established with another participant or the network. This attribute allows users to begin conversations, participate in conversations, and review previously received time-shifted messages of conversations even when there is no network available, when the network is of poor quality, or other participants are unavailable; (v) enabling the system to save media payload data at the sender and, after network transmission, saving the media payload data at all receivers; (vi) enabling the system to organize messages by threading them sequentially into semantically meaningful conversations in which each message can be identified and tied to a given participant in a given conversation; (vii) enabling users to manage each conversation with a set of user controlled functions, such as reviewing “live”, pausing or time shifting the conversation until it is convenient to review, replaying in a variety of modes (e.g., playing faster, catching up to live, jump to the head of the conversation) and methods for managing conversations (archiving, tagging, searching, and retrieving from archives); (viii) enabling the system to manage and share presence data with all conversation participants, including online status, intentions with respect to reviewing any given message in either the live or time-shifted mode, current attention to messages, rendering methods, and network conditions between the sender and receiver; (iix) enabling users to manage multiple conversations at the same time, where either (a) one conversation is current and all others are paused (MCMS); (b) multiple conversations are rendered consecutively (MCMS-C), such as but not limited to tactical communications; or (c) multiple conversations are active and simultaneously rendered (MCMS-S), such as in a stock exchange or trading floor environment; and (ix) enabling users to store all conversations, and if desired, persistently archive them in a tangible medium, providing an asset that can be organized, indexed, searched, transcribed, translated and/or reviewed as needed. For more details on the Telecommunication and Multimedia Management Method and Apparatus, see the above-mentioned U.S. application Ser. Nos. 12/028,400 and 12/192,890, both incorporated by reference herein for all purposes.

The communication devices in the above-described system include a Multiple Conversation Management System (MCMS) module and a Store and Stream (SaS) module. The MCMS module enables the user of the device to participate in and organize multiple conversations by allowing the user to perform call set-up functions, such as defining the participants of a conversation, creating and editing contact lists, starting, ending, or pausing a conversation, etc. In various embodiments, the MCMS module also allows users to engage in different conversational modes, such selecting one conversation among many for participation (MCMS), consecutively participating in multiple conversations (MCMS-C), or participating in multiple conversations simultaneously (MCMS-S). The SaS module includes a Persistent Infinite Message Buffer or “PIMB” that stores the media of conversations in a time-based format. The stored media includes both the media created on the device itself when the user is engaged in a conversation and the media created by other participants of the conversation and transmitted over the network to the device. By associating and storing the media of each conversation in the PIMB in the time-based format, the media of each conversation can be rendered either (i) “live” in a near real-time mode as the media is received over the network or (ii) in a time-shifted mode by retrieving the media of the conversation from the PIMB. The PIMB is therefore a time-shifting buffer, which allows the media of a conversation to be selectively reviewed at a time defined by the user of the device.

Storing the media of conversations in the PIMB also provides a number of other advantages. Rendering control options, such as play faster, play slower, jump to the head of the conversation, jump backward in the conversation, skip over silence or gaps, etc., may be used when rendering the media of a conversation. In addition, the stored media of the conversations can be processed in a number of ways. For example, the media can be transcribed into text, translated into other languages, searched, etc. In summary, the combination of the MCMS module and the SaS module embedded in the communication devices provides much of the advantages and functionally described above.

Currently there are millions upon millions of legacy communication devices, such as existing landline phones, cellular or mobile phones, satellite phones, radios and computers that are unable to engage in the above-described modes of communication. Without the MCMS module or the SaS module embedded in these legacy devices, they are unable to engage in or perform the aforementioned modes of communication.

U.S. application Ser. Nos. 12/206,537 and 12/206,548 both filed on Sep. 8, 2008 and both entitled “Telecommunication and Multimedia Management Method and Apparatus”, are directed to a Gateway client that provides an interface between a legacy communication device and the network it was designed to operate on, such as the Public Switched Telephone Network (PSTN), cellular networks, Internet based or VoIP networks, satellite networks, or other radio or first responder type communication networks. By connecting the Gateway client to the network, much of the above-described MCMS functionality and advantages can be provided to the user of a legacy device without the MCMS module and the SaS module embedded in the legacy device itself. Both U.S. application Ser. Nos. 12/206,537 and 12/206,548 are incorporated by reference herein for all purposes.

The Gateway client provides on the network an MCMS module and Persistent Infinite Message Buffer or PIMB module for the legacy devices. All media of a conversation, regardless if it was created by the user of the legacy device or received by the legacy device over the network, is routed through and stored in the time-based format in the PIMB module on the Gateway client. The various features and MCMS functionality are accessed and controlled by a user of a legacy device through a user interface (UI). In various embodiments, the UI is either an application downloaded and running on the legacy device or is a service accessible by the legacy device over the network. With this arrangement, users of legacy communication devices may enjoy many of the benefits and advantages of the communication devices described in U.S. application Ser. No. 12/028,400 and 12/192,890.

The present application pertains a user interface (UI) for creating, participating in, reviewing and managing one or more conversations. For each conversation, the UI generates a timeline that graphically shows the participants, their presence status, the start time, duration, and the end time of any media contribution by each participant. The timeline is progressive, meaning the timeline is updated in real-time as media is contributed to the conversation. Various tools and features are provided to enable a user to create new conversations and to review the media of existing conversations. In various embodiments, the UI of the present application may be used with the devices with the MCMS module and the SaS module including a PIMB as described in the U.S. application Ser. No. 12/028,400 and 12/192,890. Alternatively, the UI of the present invention may be used with legacy communication devices through a Gateway client as described in U.S. application Ser. Nos. 12/206,537 and 12/206,548. In this second embodiment, the PIMB is located at the Gateway client, and the UI is either an application downloaded and running on the legacy device or is a service accessible by the legacy device over the network.

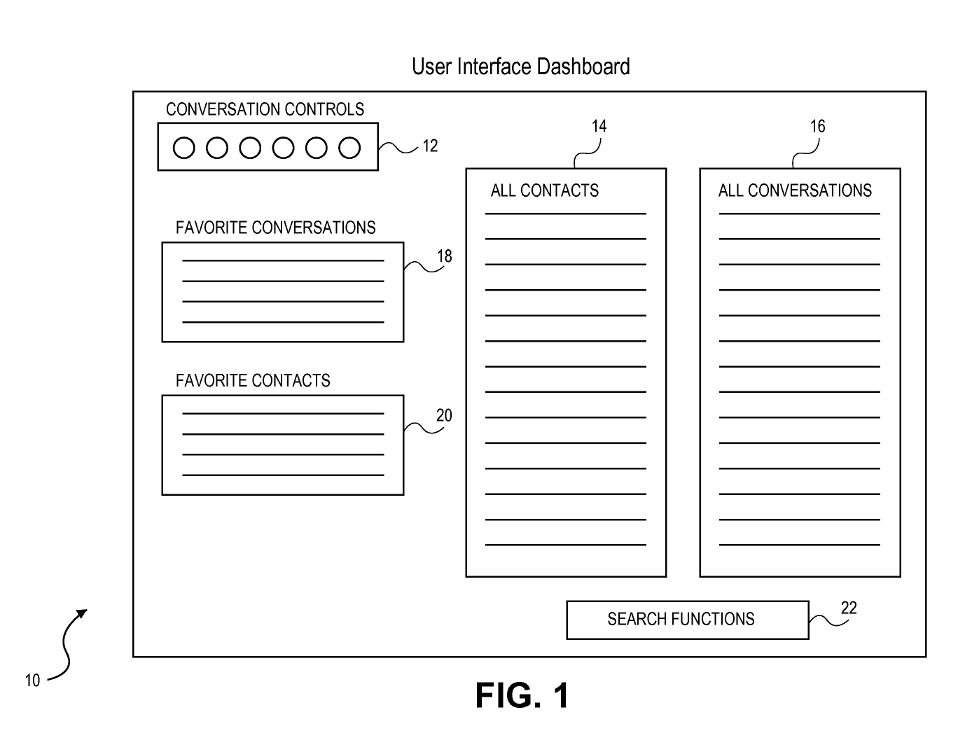

Referring to FIG. 1, an exemplary “dashboard” for the User Interface (UI) of the present invention is shown. The dashboard 10 includes a set of conversation control icons 12, a list of all contacts 14, a list of all conversations 16, a list of favorite conversations 18, a list of favorite contacts 20, and a set of search functions 22. The set of conversation control icons 12 may include such functions as start a conversation, play the media of a conversation, play the media of a conversation faster or slower, jump to the head of the conversation, mute, pause, or exit the conversation. The list of all contacts 14 is the list of contacts entered into their device. For example, this list may include associates at works, friends, family members, schoolmates, or other called individuals or organizations. The list of conversations 16 provides a complete list of all the active conversations in which the user of the device is a participant. This list may include, for instance, work related conversations with colleagues or clients, social conversations with friends, conversations with family members, etc. The favorite conversations 18 and the favorite contacts 20 are each a subset of the complete list of all contacts 14 and all conversations 16 respectively. With each subset, the user selects their preferred or most important conversations and contacts. For example, if the user repeatedly participates in a conversation with their most important client at work, then the user may wish to add that conversation to the favorite conversations list 18. Similarly, the user's preferred contacts, such as their supervisor at work, best friend, or close family member, would be included in the favorite contacts list 20. The favorite conversations list 18 and the favorite contacts list 20 each provide convenient access to frequently accessed conversations and/or contacts. While several examples are provided for defining the entries in either the favorite conversations list 18 or contacts list 20, other selection parameters may be used.

The search functions 22 enable a user to quickly search and locate specific conversations or contacts. For example, the user may conduct a search by the name of a conversation or the subject matter of a conversation. Searches by a contact name or a group of contact names may also be conducted. In either case, the conversations or contact names that match the search criteria are located and presented to the user.

The user may begin a new conversation from the dashboard 10. For example, the user may select one or more participants from either their favorite contacts list 20 or the complete contacts list 14. The user may also optionally give the conversation a name. If a participant is not already in the contact list 14, then that participant can be optionally added. Alternatively, a participant can be included in the conversation by entering their contact information into the device, such their name and telephone number. Once the participants of the conversation have been defined, and the user chooses to start the conversation immediately, then the conversation may commence. After the conversation is initiated, a user interface (UI) showing the initial conversation timeline at the start of the conversation may optionally be presented to the user.

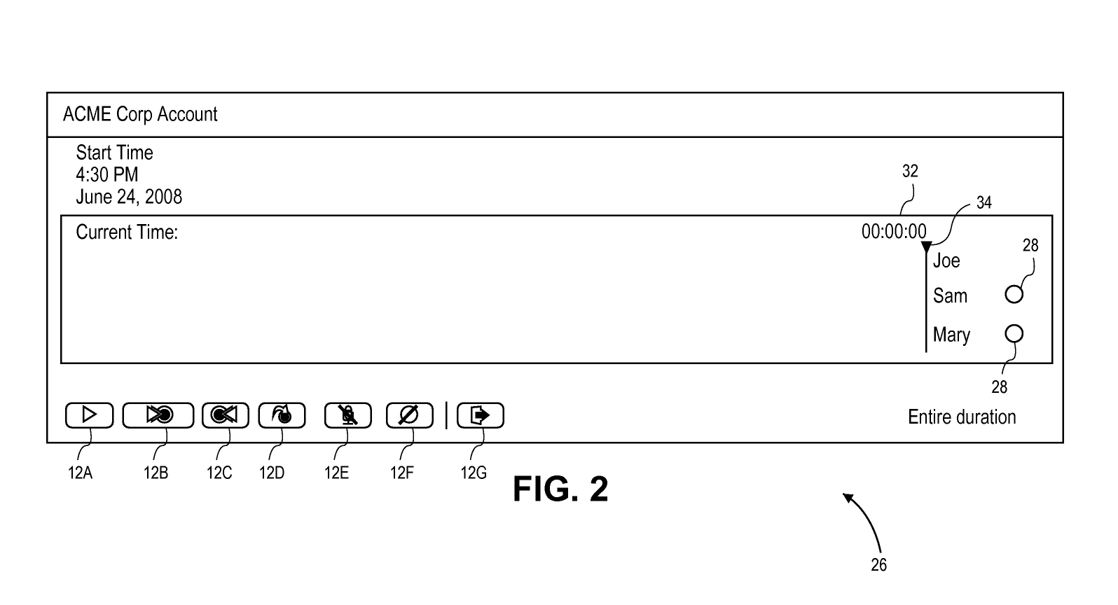

Referring to FIG. 2, a user interface display of an exemplary timeline visualization 26 at the start of the conversation is illustrated. In this example, the conversation has been named the “ACME Corp Account”, as labeled at the top of the timeline. The timeline visualization 26 also displays the start time and date of the conversation, which in this example, is 4:30 PM on Jun. 24, 2008. The participants of the conversation, whom are listed on the right side of the timeline 26, include the user “Joe” who initiated the conversation, as well as two other participants named “Sam” and “Mary”. Next to the name of each participant is a presence status indicator 28, which indicates if the participant is engaged in the conversation “live” (i.e., in the real-time mode) or in the messaging (i.e., the time-shifted mode). A timer 32 provides a running indicator of the duration of the conversation from its inception. Since in this instance the timeline visualization 26 is at the start of the conversation, the timer 32 reads 00:00:00.

A playback bar 34 is also provided. As described in more detail below, the playback bar 34 is a tool that allows the user to navigate the review of the media of the conversation. When the user is engaged in the conversation in the real-time mode, the playback bar 34 is positioned at the head of the conversation, which in this embodiment, is at the right-most position of the timeline visualization 26. When the user wishes to review previous media of the conversation, the playback bar 34 is moved to a selected previous point in time during the conversation along the timeline 26. In response, the media corresponding to the position of the playback bar 34 is retrieved from the PIMB and rendered in the time-indexed format.

The timeline visualization 26 also includes a number of conversation control tools represented by icons 12A through 12F. In the embodiment shown, the icons include a start conversation icon 12A, a play faster icon 12B, a player slower icon 12C, a jump to live or the head of the conversation 12D, a mute icon 12E, a pause icon 12F and an exit conversation icon 12G.

To begin the conversation, the user (Joe) starts the conversation by selecting the start conversation icon 12A and then speaking. As Joe speaks, the media is persistently stored the time-indexed format on the PIMB associated with Joe's communication device and then forwarded over the network to the other participants, Sam and Mary. The media generated by Sam and Mary is transmitted to and persistently stored in the PIMB associated with Joe's device and graphically displayed in the timeline 26, as described in more detail below. As discussed above, the PIMB associated with Joe's device may be located on the device itself or on a remote location, such as a gateway client.

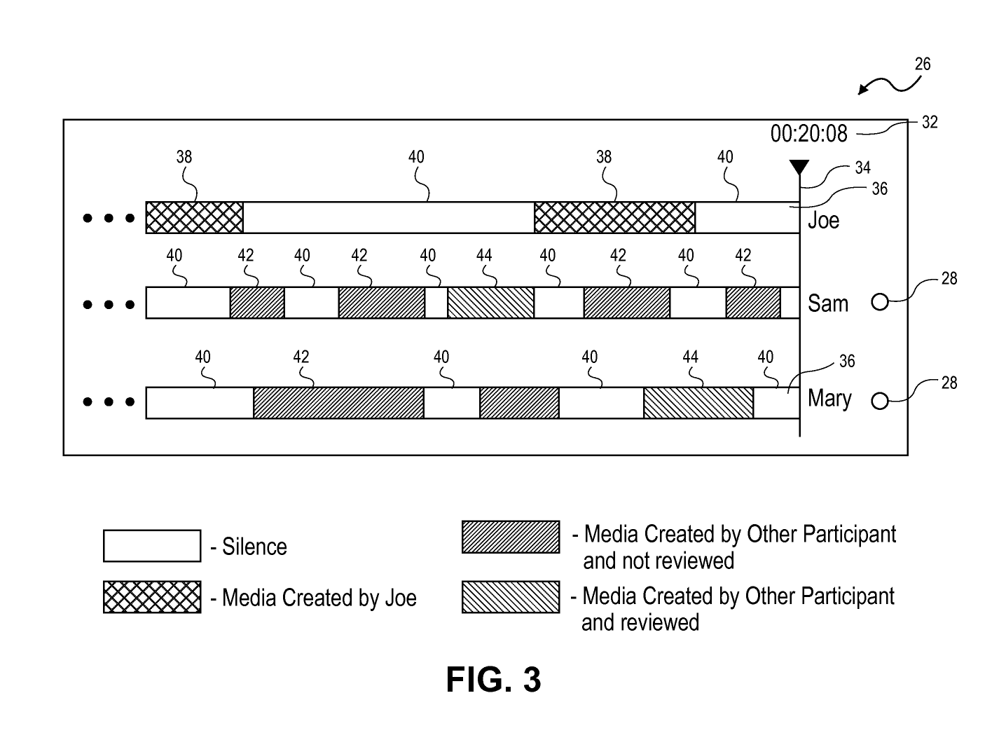

Referring to FIG. 3, an enlarged view of the media contribution of each participant of the timeline visualization 26 during the course of the conversation is illustrated. The figure is purposely illustrated showing just the media of the timeline visualization 26, without most of the other above-mentioned features and/or tools, for the sake of clarity. A media bar 36 represents the media contribution of each participant. Regions 38 (illustrated using cross-hatched lines) along the media bar 36 associated with Joe represent period of time when Joe contributed voice (or other media) to the conversation, whereas blank regions 40 represent time periods when Joe was silent. Media created by either Sam or Mary is also represented on their respective media bars 36. Forward-slash lines 42 represent the media contributed (voice or other media) by either Sam or Mary and reviewed by Joe. Back-slash lines 44 represent the media (voice or other media) contributed by either Sam or Mary but not reviewed by Joe. Blank regions 40 also designate time periods when Sam and Mary created no media. The length of each representation 38, 42 or 44 corresponds to the duration of each media contribution respectively. In addition, the representations are 38, 42 and 44 are displayed along their proper media bar 36 in time-indexed order. As a result, the representations 38, 42 and 44 each show the start time, duration and end time of each media contribution relative to both the start of the conversation and to the other representations respectively.

The media bars 36 of the timeline visualization 26 are progressively updated. When any of the participants creates new media, each of the media bars 36 are progressively updated with the appropriate representation 38, 42 or 44 at the head of the conversation. As the new media representations progressively appear on the timeline visualization 26, the previous representations on each bar 36 are scrolled in the leftward direction. As a result, the media bars 36 of the timeline visualization 26 in the aggregate provide a “scrolling” visualization of the entire history of the conversation, from the beginning of the conversation to the current point in time, along with the start time, duration and the end time of all media representations of each participant.

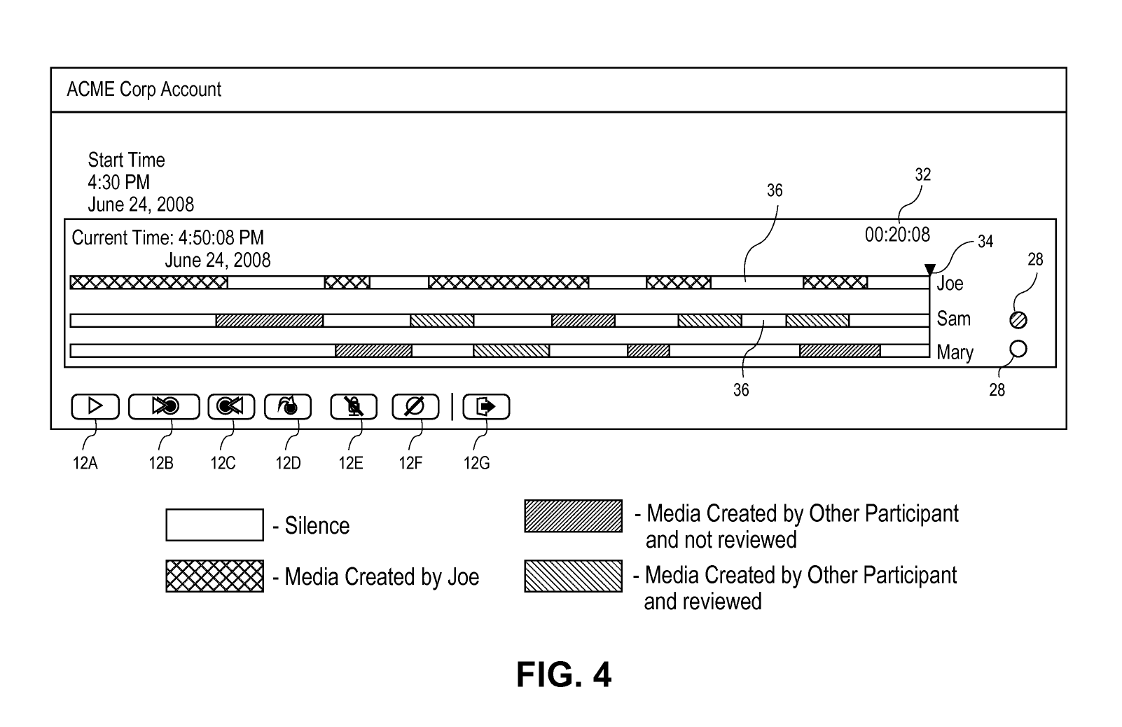

Referring to FIG. 4, a diagram illustrating the history of the ACME Corp account conversation is illustrated after the conversation has commenced for a period of time. In the diagram, the timer 32 reads “00:20:08”, indicating that twenty minutes and eight seconds have elapsed since the start of the conversation. It should be understood that the diagram illustrates the state of the conversation at the arbitrarily selected time of “00:20:08”. If a different time after the start of the conversation were selected, the diagram would reflect the state of the conversation at that time.

The presence status indicator 28 next to each participants name is used to indicate the current status of each participant. In this example, the status indicator 28 for Sam is shaded, meaning Sam is currently listening live and is engaged in the conversation in the real-time mode. On the other hand, presence status indicator 28 for Mary is not shaded, indicating her current participation status in the conversation is not live. As participants change their status from real-time to time-shifted or vice-versa, the presence status indicator 28 is updated.

By moving the playback bar 34 along the timeline visualization 26, and using the conversation controls tools 12B through 12G, the user can participate, visualize and review the media of the conversation in ways that have never before been possible. For example, by moving the playback bar 34 to the any previous point of the conversation (i.e., moving the playback bar 34 to the left to a selected representation 38, 42 or 44), the media of the conversation starting from the selected representation may be retrieved from persistent storage and played in the time-indexed format. If a user for example moves the playback bar 34 to the start of the conversation and then implements the play faster tool implemented by icon 12B, the media of each representation 38, 42 or 44 starting from the start of the conversation is retrieved from the PIMB and rendered faster than it was originally encoded, allowing the user to quickly review the media of the conversation and catch up to live or the current point of the conversation. Alternatively with the play slower tool implemented by icon 12C, the user can render the media of representations 38, 42 or 44, starting at the selected point defined by the position of the playback bar 34, slower than the media was originally encoded. This feature makes it easier to review either important media or media that was difficult to decipher at normal playback speed. In various embodiments, the rate the media is played faster or slower is variably controlled by the user. Alternatively, the user may jump to the head of the conversation by using the jump to live tool implemented by icon 12D. When implementing this function, the playback bar 34 immediately jumps to the head of the timeline visualization 26 (i.e., the right-most position of the timeline visualization 26) and begins the progressive rendering of the media of the conversation in the real-time mode. The mute tool represented by icon 12E allows the user of the device to speak without the media being recorded and made part of the conversation (i.e., no representation is created in the timeline visualization 26). The pause tool implemented by icon 12E allows the user to temporarily stop the rendering of media. Finally, the end conversation tool implemented by icon 12F allows the user to terminate their involvement in the conversation. The user may elect to return to the conversation at any time.

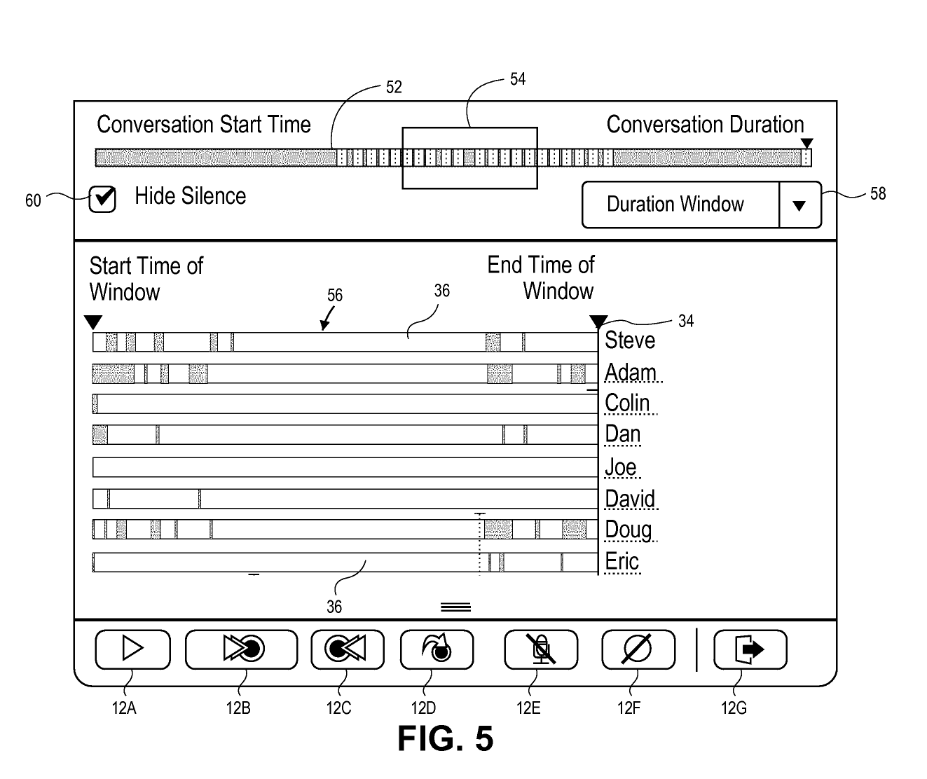

Referring to FIG. 5, a “zoom” window tool for reviewing a portion of the media of a conversation is shown according to another embodiment of the present invention. With this tool, a visually “compressed” timeline 52 for the entire duration of the conversation from the start time to the current time is displayed. The timeline 52 is compressed in the sense that the individual media representations 38, 42 and 44 of all the participants are aggregated into one media bar. A zoom window tool 54 is superimposed over the compressed timeline 52. The user may move or slide the zoom window tool 54 back and forth relative to the compressed timeline 52. As the zoom window tool is positioned over the timeline 52, a subset of the media representations 38, 42 and 44 of the compressed timeline 52 defined by the zoom window tool 54 are displayed in a corresponding timeline display window 56. As illustrated, the timeline display window 56 shows the media representations 38, 42 and 44 of each participant of the conversation defined by the zoom window tool 54. The user may review and render the media of the conversation appearing within the display window 56 using the playback bar 34 and control tools 12A through 12G as described above. By movably positioning the zoom window 54 at different locations along the timeline 52, a desired subset of the conversation, including the media representations of each participant, can be displayed in the window 56 and reviewed.

Pull down window 58 allows the user to define the time duration of the conversation defined by the zoom window tool 54. In various embodiments, the pull down menu choices may be 5, 15, 30, 45 or 60 minutes. It should be noted that these menu times are merely exemplary. Any time durations may be used. Selection box 60 allows the user to optionally either display or remove silence gaps 40 appearing in the compressed timeline 52.

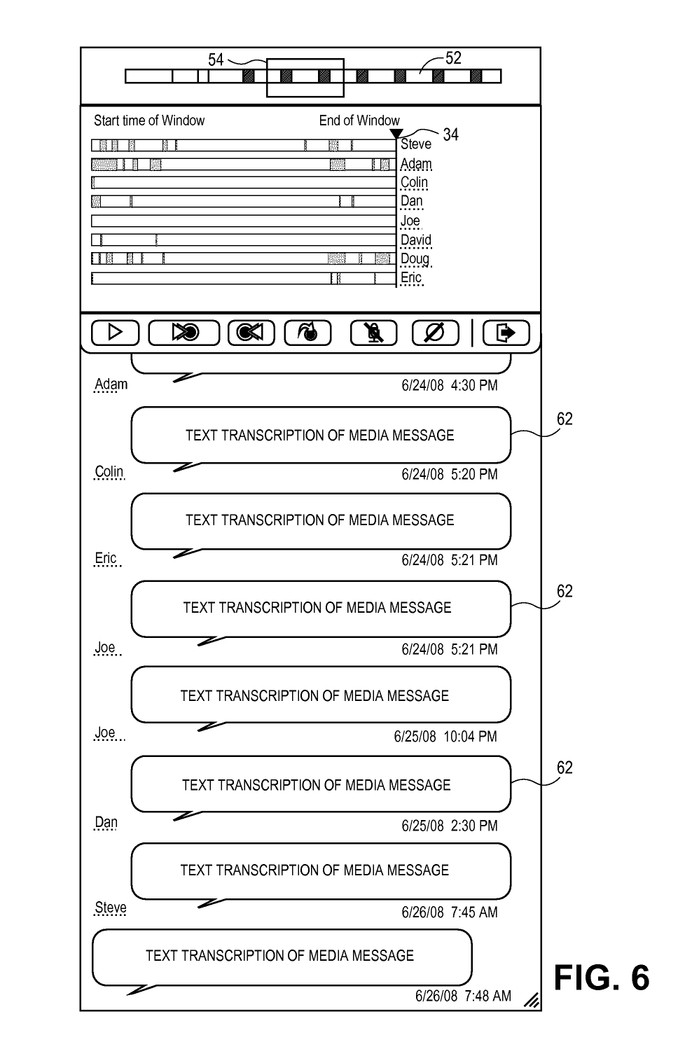

Referring to FIG. 6, another timeline visualization of a conversation including a media voice to text transcription feature is shown. As media of the conversation is created, the voice media is converted to text. The text conversion of the media is stored in the PIMB in a time-indexed format. As a result, the user may not only render the voice media of a conversation as audio, but also represent the text conversion of the media of the conversation by participant in the time-indexed format. In the example shown in the Figure, the name, text transcription, and the date and time of the messages are represented in a series of “bubbles” 62 in the time-indexed order. The voice to text conversation can be generated and displayed in either real-time during an ongoing conversation or in the time-shifted mode where the voice and text media is retrieved from PIMB storage and displayed based on the position of the playback bar 34 or the zoom window 54. By manipulating the playback bar 34 or the zoom window 54, the bubbles 62 of the conversation may be scrolled through starting at any point of the conversation. In various embodiments, the voice to text conversation may be performed by any known speech recognition or voice to text conversion software.

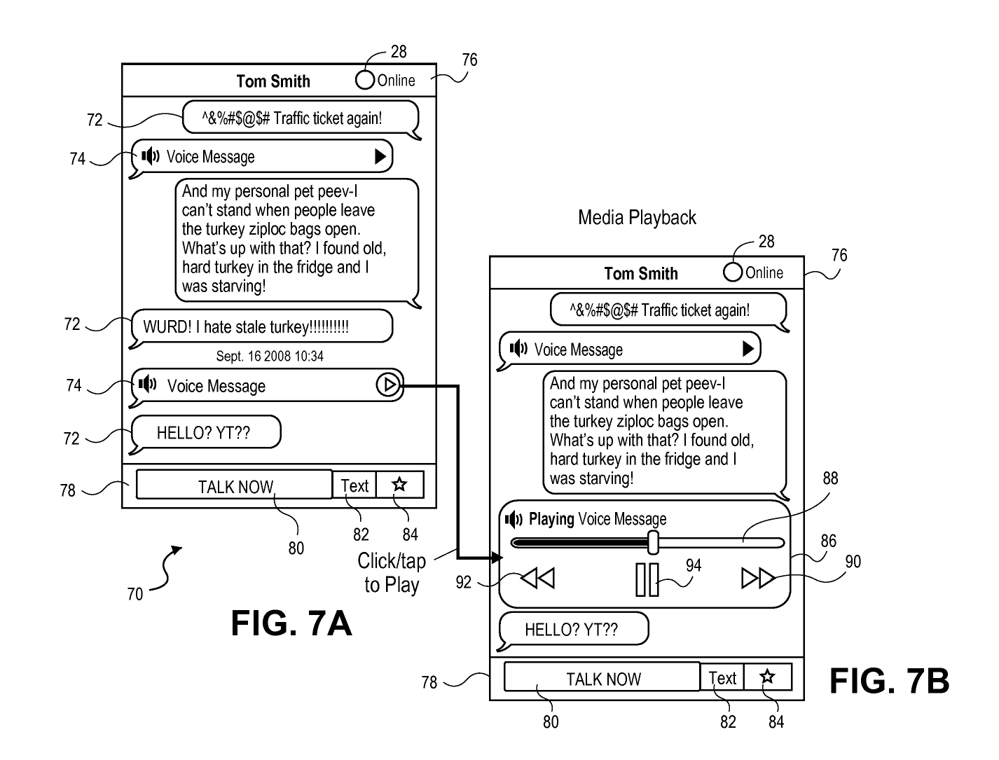

Referring to FIG. 7A, an embodiment of another timeline visualization 70 for displaying the details of a conversation on a communication device is illustrated. In this embodiment, the individual messages of a conversation are represented in a series of “bubbles” 72. The individual bubbles 72 are sequentially displayed in the time-order in which they were created. The individual bubbles 72 may include a text message, a voice message, video or sensor data, such as temperature, GPS or positional data, etc. An icon 74 representative of the type of media may optionally be provided within each bubble 72. For example, icons such as a speaker, an envelope, a video camera, or a thermometer may be used to represent voice, text, video and temperature sensor data respectively. It should be understood that the specific icons used may vary and should not be limited to those listed or illustrated herein.

In one embodiment, the bubbles 72 representing the most recently created messages are provided at the top of the display and the bubbles 72 representing the older messages are provided at the bottom of the display. By scrolling up and down through the bubbles 72 of the conversation, the entire history of the conversation, from inception to the most recent bubble 72, may be reviewed. The scrolling may be initiated using a number of known user input options, such as the use of scrolling up/down arrows or by dragging a finger or some other type of input device, such as a stylus or pen, up and down on a touch-screen display. In one alternative arrangement, the complement of the above may be implemented, with the most recently created messages represented by bubbles 72 are provided on the bottom and the oldest created messages represented by bubbles 72 appearing on the top of the display. In yet other embodiments, the messages of the conversation represented by the bubbles 72, from most recent to the oldest, may scroll from side to side (i.e., from left-to-right or right-to-left).

A window 76 is provided at the top of the display 70. When one of the bubbles 72 is selected for review, the name of the sender (e.g., “Tom Smith”) appears in the window 76 along with their current presence status, as represented by indicator icon 28. As different bubbles 72 are selected for review, the name and presence status of the sender is updated in the window 76.

A window 78 provided at the bottom of the display 70 is used for the creation of messages. A “talk now” icon 80 allows the user to create a voice message associated with the displayed conversation. By selecting the talk now icon 80 and speaking into the device, the spoken media is progressively encoded, stored in the PIMB associated with the device, and transmitted to the other participants of the conversation. In addition, the message is represented in a bubble 72 and inserted into the conversation timeline 70 in its proper time-sequence. A text icon 82 enables a user to create a text message using a keyboard (not illustrated) provided on the device or elsewhere. By selecting the icon 82, typing a text message, and then selecting the icon 82 again, a text message is created, stored in the PIMB in time-indexed order, transmitted to other participants and represented as a bubble 72 in its proper time-sequence of the timeline 70. A “favorite” icon 84 is used for adding the currently displayed conversation into the favorite conversations list 18. Although not illustrated, messages containing other types of media, such as video, still picture, or sensor data may be created and inserted into the conversation in the time-indexed order in a similar manner as described above.

The playback of voice messages is accomplished selecting (e.g., by clicking, tapping or by some other input function) the appropriate bubble 72 containing the desired voice message. When this occurs, a play window 86 appears or is superimposed over the location of the selected bubble 72, as illustrated in FIG. 7B. Within the play window 86, a play bar 88, which shows the progression of the playback of the voice media, as well as play forward 90, return 92 and pause icon 94 are provided. When the play forward icon 90 is selected once, the playback of the voice media occurs at the same rate the media was originally encoded. Clicking the icon 90 multiple times or selecting and holding the icon 90 for an extended period of time increases the play forward speed of the voice message. Return icon 92 may be used in a similar manner to control the speed the rendering point is returned to a previous point in time in the voice message.

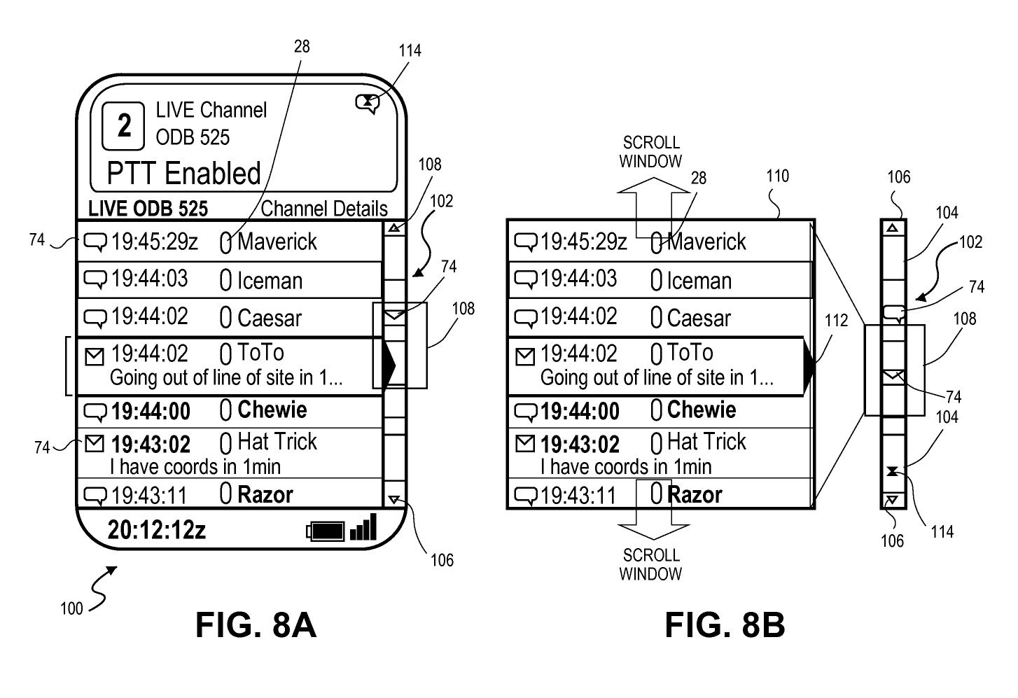

Referring to FIG. 8A, a user interface display 100 with another timeline visualization 102 of a conversation is illustrated. In this embodiment, the conversation timeline 102 is provided on the right side of the display. The timeline 102 includes a number of segments 104, each representing a message of a conversation. The individual segments 104 are organized in a sequential time-indexed order. In one embodiment, the most recent messages are displayed on the top and the oldest messages are displayed at the bottom or the timeline 102. In an alternative embodiment, most recent messages are provided on the bottom and the oldest messages are on the top of the time line 102. In yet other embodiments, the individual segments 104 may be color coded to graphically display messages that have been previously reviewed. Segments that are shaded may signify messages that have been reviewed, whereas segments that have not been shaded signify messages that have not yet been reviewed. The individual segments 104 may optionally include an icon 74 indicative of the type of media contained in the message.

Scrolling arrows 106 are provided at the top and the bottom of the segments 104 of the timeline visualization 102. The arrows 106 enable the user to scroll up and down the segments of the timeline visualization 102. In many instances, there are too many segments 104 for a given conversation to display all at once. The arrows 106 allow the user to navigate up and down the entire duration of the conversation, from the initial message to the most recent message. When one of the arrows 106 is used, it causes the scrolling of segments 104 of the conversation to appear in the display in the direction of the selected arrow.

A focal window 108 is also provided adjacent the segments 104 of the timeline visualization 102. The focal window 108 defines a subset of the segments 104 along the timeline 102. Information pertaining to the subset of segments 104 defined by the focal window is displayed in a scroll window 110. Although this feature is illustrated in FIG. 8A, it is most clearly illustrated in FIG. 8B. As the segments 104 are scrolled relative to the focal window 108, the subset of segments 104 displayed in window 110 is progressively and correspondingly updated. In various embodiments, the information per segment displayed within the scroll window 110 includes one or more of the following: the name of the sender, a presence status indicator 28, the time the message was created, an icon indicative of the type of media contained within the segment, an indicator to indicate of the segment was previously reviewed or not, a presence status indicator to indicate the presence status of the participant who created the message of the segment, and/or another indicator to indicate if the media of the message segment was received out of time-indexed order.

Information pertaining to any media representation of the conversation may be displayed in the window 110 by scrolling up and down the segments of the timeline visualization 102 using the arrows 106 relative to the focal window 108. Once a representation of a segment 104 appears within the window 110, the media of that segment 104 may be selected and reviewed. In one embodiment, clicking or tapping within window 110 may select a particular segment in the window 110. When this occurs, a select arrow 112 appears next to the selected message and the media of that message is rendered. More specifically, voice messages are rendered through a speaker. With a text message, the text of the message is displayed. Alternatively, video, photo or sensor data contained within the message will appear on the display.

Lastly, an icon 114 may be provided to signify that a message has been received out of its time-sequence order. This typically occurs when a participant of the conversation generates a message when they have poor or no network connectivity. For example, when a participant generates a message while out of network range, the message is locally stored in the PIMB of the sending device. When network connectivity improves or is restored, the message is transmitted out of PIMB storage over the network to the other participants of the conversation. The icon 114 is used to both notify the recipient that a message has been received out of the proper time-indexed order and to signify that the corresponding segment 104 was received out of order, but placed into the proper time sequence order in the timeline 102. For more details on the saving and transmission of messages out of PIMB storage, see U.S. application Ser. No. 12/212,595 filed on Sep. 17, 2008 and entitled “Graceful Degradation for Voice Communication Services Over Wired and Wireless Networks, incorporated by reference herein for all purposes.

In various embodiments, the icon 114 may appear in the individual segment 104 that was received out of its time-sequence order. When this occurs, the segment, with the icon 114, is inserted into the proper time-sequenced location in the timeline 102. In addition, the icon 114 may also appear in a display window to notify the recipient that an out of time order message has arrived. In the embodiment shown in the example of FIG. 8A, the icon 114 appears in the upper right corner of the display. When the recipient selects this icon, the corresponding out of time-sequence order message will appear in both the timeline 102 an the window 110, providing the option of the recipient to immediately review the message if desired.

The conversation navigation tools 12A-12F, playback bar 34, media bars 36, presence indicators 28 zoom window 54, and control functions 12A through 12F, media representations, 38, 42 and 44, compressed timeline 52, bubbles 62 and 72, media type icons 74, play window 86, media control icons 88-94, timeline 102, arrows 106, focal window 108, and select arrow, and all other icons and tools as described herein are merely exemplary. It should be understood that any well known GUI functions, such as touch screens, drag and drop elements, scrolling elements, and other known input and select elements that implement similar functions as described herein may be used in various implementations. Given that the number of available tools is so numerous, it would be virtually impossible to describe them all in their different variations and embodiments herein. Accordingly, the specific embodiments described herein should not be construed as limiting. Rather, each function should be broadly considered and may be implemented in any of the number of known GUI tools or functions, regardless if described or not described herein.

Although many of the components and processes are described above in the singular for convenience, it will be appreciated by one of skill in the art that multiple components and repeated processes can also be used to practice the techniques of the system and method described herein. Further, while the invention has been particularly shown and described with reference to specific embodiments thereof, it will be understood by those skilled in the art that changes in the form and details of the disclosed embodiments may be made without departing from the spirit or scope of the invention. For example, any well known GUI type icons, tools displays and input techniques may be used in substitution of those specifically described, illustrated or otherwise used herein. It is therefore intended that the invention be interpreted to include all variations and equivalents that fall within the true spirit and scope of the invention.

What is claimed is:

1. A user interface, comprising:
a timeline visualization of a voice conversation, the timeline visualization including one or more representations of the voice media contributions by one or more participants of the conversation respectively, the timeline visualization further configured to progressively display the one or more representations as the voice media is being created by the one or more participants during the conversation respectively; and
one or more navigation tools for navigating the one or more representations of the timeline visualization of the conversation and for selecting for review the voice media of the one or more representations.

2. The user interface of claim 1, further comprising displaying time information associated with each of the one or more representations respectively, the time information consisting of one of the following:
(i) the start time of the voice media;
(ii) the start time of the voice media relative to either (a) the other one or more representations, (b) the start of the conversation, or (c) both (a) and (b);
(iii) the end time of the voice media;
(iv) the end time of the voice media relative to either (a) the other one or more representations, (b) the start of the conversation, or (c) both (a) and (b); or
(v) any combination of (i) through (iv).

3. The user interface of claim 1, wherein the timeline visualization of the conversation further comprises one or more media bars each corresponding to the one or more participants respectively, each of the one or more media bars graphically displaying the one or more representations contributed by the one or more participants respectively.

4. The user interface of claim 3, wherein the one or more representations are displayed in time-indexed order for each of the one or more media bars respectively.

5. The user interface of claim 3, wherein each of the one or more representations graphically displays the duration of the voice media contribution respectively.

6. The user interface of claim 1, further comprising graphically displaying in the timeline visualization where the voice media of the one or more representations have been reviewed or not reviewed respectively.

7. The under interface of claim 1, wherein the one or more navigation tools for navigating the one or more representations comprises a playback bar that may be moved along the timeline visualization of the conversation, the position of the playback bar defining the starting point for the one or more representations to be rendered when reviewing the voice media of the conversation.

8. The user interface of claim 1 further comprising a compressed timeline visualization of the conversation that extends from the start through the duration of the conversation, the compressed timeline graphically showing an aggregation of the one or more representations of the one or more participants of the conversation compressed into the compressed timeline visualization.

9. The user interface of claim 8, wherein one of the one or more navigation tools includes a zoom window tool that is movably positioned relative to the compressed timeline, the zoom window tool defining a subset of the one or more representations of the conversation to be displayed in a corresponding display window, the displayed subset being updated as the zoom window tool is moved relative to the compressed timeline.

10. The user interface of claim 9, further comprising a zoom window duration element configured to selectively define the time duration of the one or more representations defined by the zoom window tool to be displayed in the corresponding display window.

11. The user interface of claim 8, further comprising a selection element configured to optionally display or remove silence gaps in the compressed timeline visualization of the conversation.

12. The user interface of claim 1, wherein the one or more the representations comprise one or more media bubbles respectively.

13. The user interface of claim 12, wherein the one or more media bubbles are sequentially organized in time-indexed order respectively.

14. The user interface of claim 12, wherein one or more of the media bubbles contains a voice to text conversion of the one or more representations of the voice media contributions of the conversation respectively.

15. The user interface of claim 12, wherein the one or more navigation tools comprises a scrolling element configured to scroll through the one or more media bubbles of the conversation.

16. The user interface of claim 12, further comprising a play window which appears when one of the media bubbles containing voice media is selected, the play window providing rendering tools to render the voice message associated with the selected media bubble.

17. The user interface of claim 1, wherein the one or more representations included in the timeline visualization comprise one or more segments consecutively organized in time-indexed order respectively.

18. The user interface of claim 17, wherein each of the one or more segments is configured to graphically represent if the voice media contribution of each segment has been reviewed or not reviewed respectively.

19. The user interface of claim 17, wherein the one or more navigation tools further comprises a scrolling element configured to scroll through the one or more segments of the timeline visualization of the conversation.

20. The user interface of claim 17, wherein the one or more navigation tools further comprises a focal window provided adjacent the one or more segments, the focal window defining a subset of the one or more segments to be displayed in a corresponding scroll display.

21. The user interface of claim 20, wherein the subset of the one or more segments displayed in the corresponding scroll display is progressively updated as the segments are scrolled relative to the focal window.

22. The user interface of claim 21, wherein scroll display displays information pertaining to each segment in the subset, the information comprising one of the following:
(i) the name of the participant that created the message;
(ii) the time the message was created;
(iii) an icon indicative of the type of media contained in the message;
(iv) a first indicator to indicate if the message was previously reviewed or not;
(v) a presence status indicator to indicate the presence status of the participant that created the message;
(vi) a second indicator to indicate if the message was received out of time-indexed order; or
(vii) any combination of (i) through (vi).

23. The user interface of claim 17, wherein the one or more segments each include an icon indicative of the type of media contained within the one or more segments respectively.

24. The user interface of claim 1, further comprising an icon notifying if a media contribution of the conversation was received out of time-indexed order.

25. The user interface of claim 1, further comprising one or more presence status indicators configured to indicate the presence status of the one or more participants respectively, the presence status being either participating in the conversation in a real-time mode or in a time-shifted mode.

26. The user interface of claim 1, wherein the one or more tools to navigate the one or more representations of the voice media of the conversation further comprises tools to perform one or more of the following functions:
(i) start the conversation;
(ii) play faster;
(iii) play slower;
(iv) jump to live or head of the conversation;
(v) mute;
(vi) pause; or
(vii) exit the conversation.

27. The user interface of claim 1, further comprising one or more of the following:
(i) an all contacts list;
(ii) a favorite contacts list;
(iii) an all conversation list; or
(iv) a favorite conversation list.

28. The user interface of claim 1, wherein the media of the conversation comprises, in addition to voice media, one of the following: audio, video, text, still pictures or photos, GPS or positional data, sensor data, or any combination thereof.

29. The user interface of claim 12, further comprising one or more icons indicative of the type of media associated with each media bubble, the one or more icons indicative of the following types of media: a text message, a voice message, a text translation of a voice message, video, still pictures or photos, GPS or positional data, sensor data, or any combination thereof

30. The user interface of claim 1, wherein the conversation comprises other types of media besides voice media and the one or more representations included in the timeline visualization represent these other types of media.

31. The user interface of claim 30, wherein the other types of media consist of one or more of the following: video, photos, audible sounds, positional or GPS information, or sensor information.
